(19) United States
(12) Patent Application Publication
(10) Pub. No.: US 2009/0290922 A1
(43) Pub. Date: Nov. 26, 2009

(54) Image forming apparatus

(75) Inventor: Mami Endo, Yokohama city (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/453,464

(22) Filed: May 12, 2009

(30) Foreign Application Priority Data
May 13, 2008 (JP) 2008-125733

(51) Int. Cl. G03G 15/00

(52) U.S. Cl. 399/405

(57) ABSTRACT

An image forming apparatus includes an ejection tray and a first function enhancement unit. The ejection tray projects from one side of the image forming apparatus, and receives a recording medium ejected after an image is recorded on the recording medium. The first function enhancement unit is detachably attached to the one side of the image forming apparatus. A bottom face of the first function enhancement unit is positioned above the ejection tray, and a front side of the first function enhancement unit is positioned at rearward from a sheet centerline in a sheet transport direction of the recording medium ejected onto the ejection tray.

### CROSS-REFERENCE TO RELATED APPLICATIONS

This application claims priority to Japanese Patent Application No. 2008-125733, filed on May 13, 2008 in the Japan Patent Office, the entire contents of which are hereby incorporated by reference herein.

### BACKGROUND OF THE INVENTION

1. Field of the Invention

The present invention relates to an image forming apparatus provide with a function enhancement unit.

2. Description of the Background Art

Typically, image forming apparatuses such as a copier, a facsimile machine, and a multi-functional image processing apparatus having copy and facsimile function are designed to be compact in size while including as many functions as possible. In some cases, a specific function, which may not be used so often, may be added to an image forming apparatus after a user purchases the image forming apparatus. Such a seldom-used function may be added to the image forming apparatus by connecting a function enhancement unit to a standard model apparatus. Typically, the function enhancement unit may be connected to a peripheral portion of the image forming apparatus.

However, if the function enhancement unit is added to the peripheral portion of the image forming apparatus, a total footprint area of the apparatus increases as a result even if the original standard model apparatus is compact in size.

Accordingly, JP-2005-31444-A describes an image forming apparatus that has a sheet ejection space inside the apparatus, in which a retractable plate is disposed at an upper portion of the sheet ejection space. A function enhancement unit can be attached on the retractable plate. The retractable plate is withdrawably attached to the image forming apparatus to place the function enhancement unit on the retractable plate. Accordingly, when the function enhancement unit is not used, the retractable plate is placed inside the image forming apparatus, by which a total footprint area of apparatus can be reduced.

However, in the configuration described in JP-2005-31444-A, the function enhancement unit may be added and fixed to the image forming apparatus by projecting and extending the retractable plate outside of the image forming apparatus. Therefore, if the image forming apparatus has an ejection tray projecting outside of the apparatus, such retractable plate may interfere with recording sheets ejected to the ejection tray when the retractable plate is withdrawn from the image forming apparatus, thus preventing the sheets from being removed from the ejection tray efficiently.

### SUMMARY

In one aspect of the invention, an image forming apparatus includes an ejection tray and a first function enhancement unit. The ejection tray projects from one side of the image forming apparatus, and receives a recording medium ejected after an image is recorded on the recording medium. The first function enhancement unit is detachably attached to the one side of the image forming apparatus. A bottom face of the first function enhancement unit is positioned to a position above the ejection tray, and a front side of the first function enhancement unit is positioned at rearward from a sheet centerline in a sheet transport direction of the recording medium ejected onto the ejection tray.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 illustrates a perspective view of an image forming apparatus according to a first exemplary embodiment, viewed from a front and side direction;

FIG. 2 illustrates a front view of the image forming apparatus of FIG. 1;

FIG. 3 illustrates a top view of the image forming apparatus of FIG. 1;

FIG. 4 illustrates a perspective view of a function enhancement unit when attached to one side of the image forming apparatus of FIG. 1;

FIG. 5 illustrates a rear view of an attachment member according to a first exemplary embodiment;

FIG. 6 illustrates a bottom view of an additional function unit according to a first exemplary embodiment;

FIG. 7 illustrates a top view of an attachment member according to a first exemplary embodiment;

FIG. 8 illustrates a perspective view of a function enhancement unit when attached to another side face of the image forming apparatus of FIG. 1;

FIG. 9 illustrates a perspective view of the image forming apparatus attached with a function enhancement unit on both side of the image forming apparatus of FIG. 1, viewed from a front and side direction;

FIG. 10 illustrates a perspective view of an image forming apparatus according to a second exemplary embodiment, viewed from a rear and side direction;

FIG. 11 illustrates a perspective view of an image forming apparatus according to a third exemplary embodiment, viewed from a rear and side direction; and

FIG. 12 illustrates a partial front of the image forming apparatus of FIG. 11 illustrating a relative position of function enhancement units.

The accompanying drawings are intended to depict example embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION OF EXAMPLE EMBODIMENTS

A description is now given of example embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or, groups thereof.

Furthermore, although in describing expanded views shown in the drawings, specific terminology is employed for the sake of clarity, the present disclosure is not limited to the specific terminology so selected and it is to be understood that each specific element includes all technical equivalents that operate in a similar manner.

Referring now to the drawings, an image forming apparatus according to an example embodiment is described. The image forming apparatus may employ electrophotography, for example, and may be used as a copier, a printer, a facsimile, or a multi-functional imaging apparatus which may include copy and facsimile function, but not limited thereto.

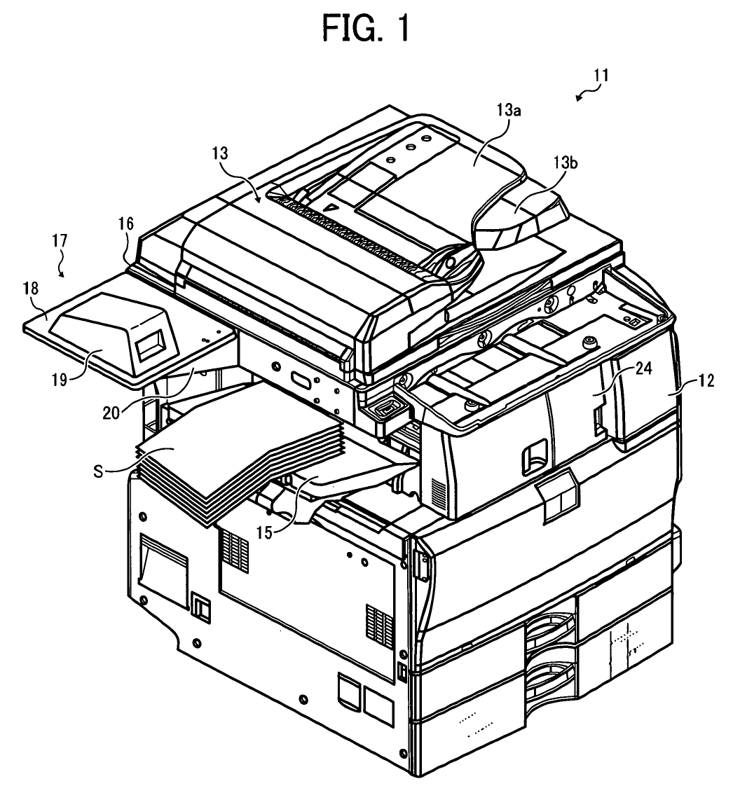

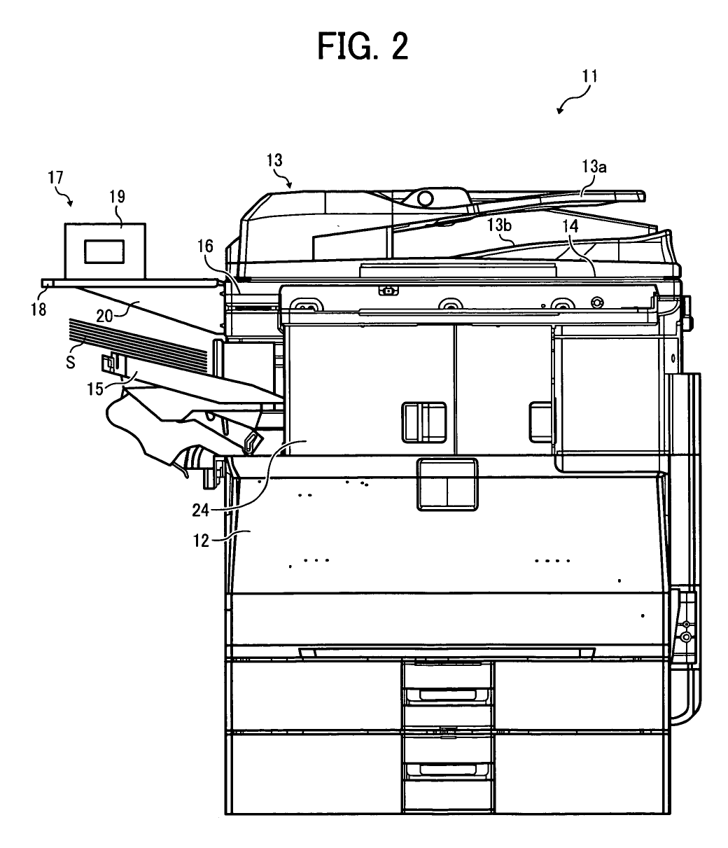

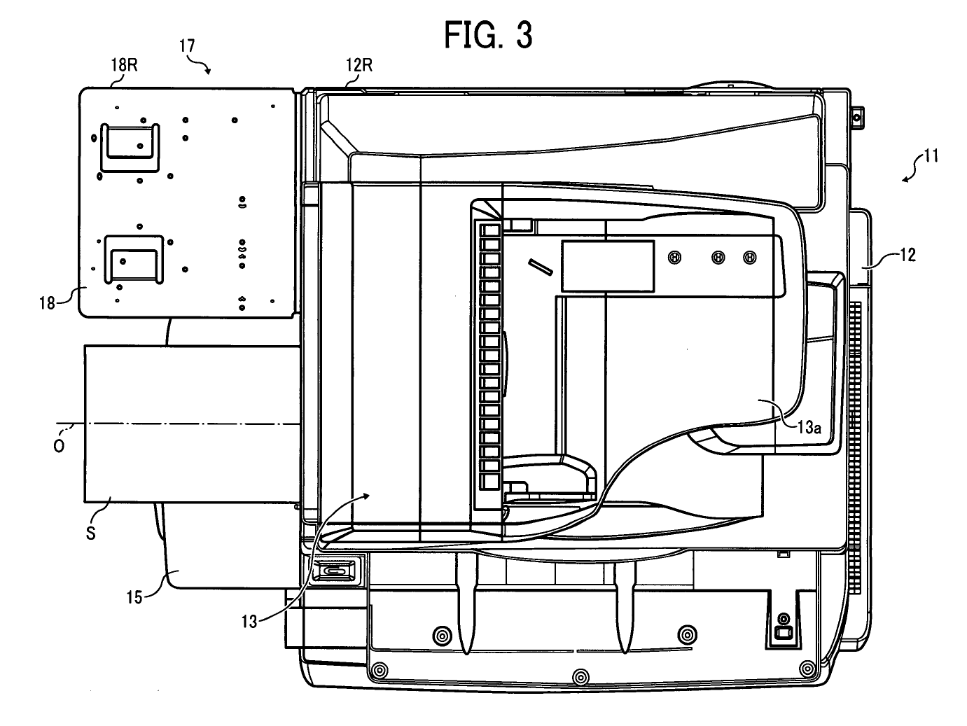

FIGS. 1 to 9 illustrate an image forming apparatus 11 according to a first exemplary embodiment. FIG. 1 illustrates a perspective view of the image forming apparatus 11 viewed from a front and side direction, FIG. 2 illustrates a front view of the image forming apparatus 11, and FIG. 3 illustrates a top view of the image forming apparatus 11.

As shown in FIGS. 1 to 3, the image forming apparatus 11 includes an apparatus body 12, and an automatic document feeder 13 (hereinafter, ADF 13) disposed above the apparatus body 12, for example. The ADF 13 may be attached to the apparatus body 12 with a hinge mechanism, by which the ADF 13 is pivotably opened and closed on the apparatus body 12.

The ADF 13 includes a document tray 13a and a sheet receiver 13b. Document sheets placed on the document tray 13a can be separated one by one and transported to a contact glass 14 (see FIG. 2) disposed on a topside of the apparatus body 12. The document placed on the contact glass 14 is scanned by an image scanner 16, and then ejected to the sheet receiver 13b. The image scanner 16 may include a light source, a mirror, a lens, and a charge coupled device (CCD), for example, to scan an image.

The image forming apparatus includes an image forming unit in the apparatus body 12, which forms an image on a recording medium such as a recording sheet. The image forming unit includes a photoconductor drum, a development unit, a transfer belt, a cleaning unit, a charge unit, a de-charge unit, and a fixing unit, for example. The fixing unit fixes a toner image on the recording sheet.

Further, the apparatus body 12 may be disposed with an ejection tray 15. For example, the ejection tray 15 may project from one side of the apparatus body 12 as shown in FIG. 1. The ejection tray 15 receives the recording sheet S, which has a recorded image, from the image forming unit. For example, the recording sheet S may be ejected to the ejection tray 15 by passing through the recording sheet S under the image scanner 16. Further, a finisher unit may be disposed in the image forming apparatus 11. The finisher unit may be accessed when a cover 24 is opened, wherein the cover 24 is disposed on a front side of the image forming apparatus 11. The cover 24 may be slide-able on the apparatus body 12 as shown in FIG. 1.

Further, a function enhancement unit 17 may be detachably disposed on one side face of the apparatus body 12. The function enhancement unit 17 may include an attachment member 18 and an additional function unit 19, for example. The attachment member 18 is detachably attached on one side of the apparatus body 12, and the additional function unit 19 is attached on one face (e.g., top face) of the attachment member 18. In FIG. 3, the additional function unit 19 is omitted.

The additional function unit 19 may be a function unit, which is used for a specific purpose. For example, the additional function unit 19 may be a billing unit. The billing unit may include a key counter, a key card reader, an integrated circuit (IC) card reader, and a finger print sensor, for example. The billing unit may bill a user, identified by user information, at each time when a given service operation, such as for example an image printing on a recording sheet, is conducted. Further, the additional function unit 19 may be another function unit, which can be used for another specific purpose.

As shown in FIGS. 1 and 2, the attachment member 18 may be disposed over the ejection tray 15 in a vertical direction, for example. Further, a front side of the attachment member 18 may be positioned at a rearward with respect to a sheet centerline O for a sheet transport direction (see FIG. 3) of the recording sheet S ejected on the ejection tray 15. The sheet centerline O is a center of sheet when the ejected sheet is transported onto the ejection tray 15. As shown in FIG. 3, the sheet centerline O may be a line extending in a long side direction of sheet. For example, the sheet may be a B5-size sheet. The sheet centerline O may be set at a given position on the ejection tray 15 by design consideration.

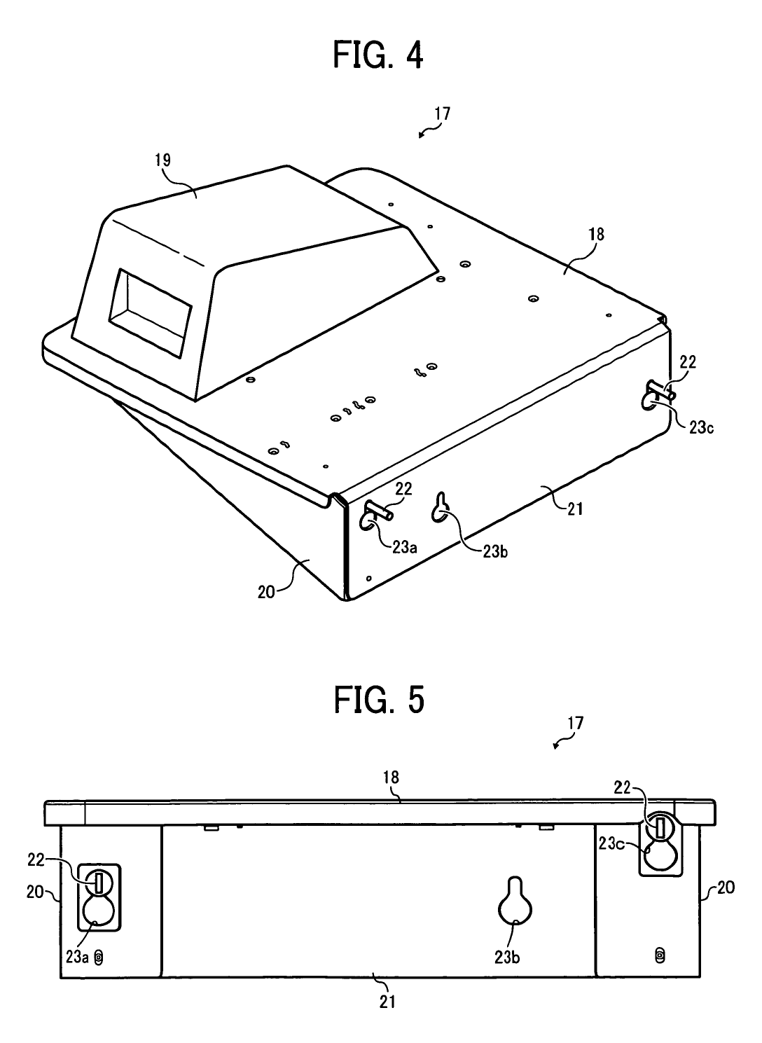

Further, the top face of the attachment member 18 may be positioned at a height substantially same as the contact glass 14, for example. As shown in FIGS. 4 and 5, the attachment member 18 may be provided with a reinforcing member 20, and a fixing member 21. The reinforcing member 20, which may have a triangular shape, may be disposed at two end side of a bottom face of the attachment member 18 (see FIG. 5). The fixing member 21, which may be disposed at one side of the bottom face of the attachment member 18, may be attached to an attachment face of the apparatus body 12.

As shown in FIG. 2, the ejection tray 15, projecting from the one side of the apparatus body 12, may slant up and out from the one side of the image forming apparatus with respect to a horizontal plane. For example, the ejection tray 15 slants up to an upward direction. Further, as shown in FIG. 2, the bottom face of the reinforcing member 20, projecting from the one side of the apparatus body 12, may slant up and out from the one side of the image forming apparatus with respect to a horizontal plane. For example, the bottom face of the reinforcing member 20 slants up to an upward direction. Accordingly, a gap between the ejection tray 15 and the bottom face of the reinforcing member 20 in a vertical direction, which project from the one side of the apparatus body 12, can be maintained at a substantially constant distance.

Further, the one side of the apparatus body 12 includes a plurality of screw holes to be screwed by screws 22 (see FIGS. 4 and 5). As shown in FIGS. 4 and 5, the fixing member 21 includes opening portions 23a, 23b, and 23c, which can be aligned with any one of the screw holes formed on the apparatus body 12. The attachment member 18 can be fixed to the apparatus body 12 by inserting and screwing the screws 22 to the opening portions 23a, 23b, and 23c and the corresponding screw holes of the apparatus body 12. For example, the attachment member 18 can be fixed to the apparatus body 12 using the opening portions 23a and 23c and two screws 22. Further, the number of screw holes of apparatus body 12 may be set greater than the number of the opening portions 23a, 23b, and 23c, for example.

As such, the attachment member 18 can be fixed to the apparatus body 12 by inserting and screwing the screws 22 to the opening portions 23a, 23b, and 23c and the corresponding screw holes of the apparatus body 12, for example. With such a configuration, the additional function unit 19 can be fixed to the one side of the apparatus body 12. As shown in FIG. 5, the attachment member 18 can be fixed to the apparatus body 12 using the opening portions 23a and 23c, the two screw holes of the apparatus body 12, and the two screws 22, inserted and screwed in the opening portions and screw holes, for example.

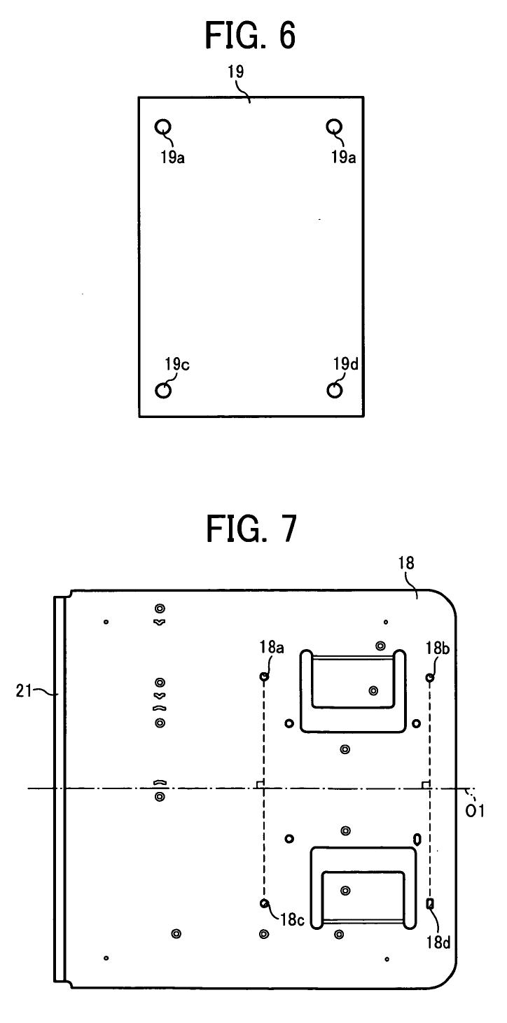

Further, as shown in FIG. 6, a plurality of screw holes 19a to 19d may be formed on a bottom face of the additional function unit 19. As shown in FIG. 7, a plurality of openings 18a to 18d may be formed on the attachment member 18. Screws may be screwed to the screw holes 19a to 19d and the openings 18a to 18d to fix the additional function unit 19 on the attachment member 18. Each of the openings 18a to 18d can be aligned with any one of the screw hole 19a to 19d even when the additional function unit 19 is rotated for a given angle such as for example 180 degrees.

Specifically, the openings 18a to 18d may be formed at symmetrical positions on the attachment member 18 with respect to a centerline O1 extending in a projection direction of the attachment member 18 as shown in FIG. 7. The centerline O1 extending in the projection direction of the attachment member 18 may be a line, which extends in a direction from the apparatus body 12, parallel to a projection direction of the attachment member 18. The openings 18a to 18d may be formed at a relatively outer end of the attachment member 18 as shown in FIG. 7. For example, the openings 18a and 18b may be symmetrically positioned with respect to the centerline O1 of the attachment member 18, and the openings 18c and 18d may also be symmetrically positioned with respect to the centerline O1 of the attachment member 18.

As such, the additional function unit 19 can be attached and fixed to the attachment member 18 by inserting and screwing screws into the openings 18a to 18d and the screw hole 19a to 19d.

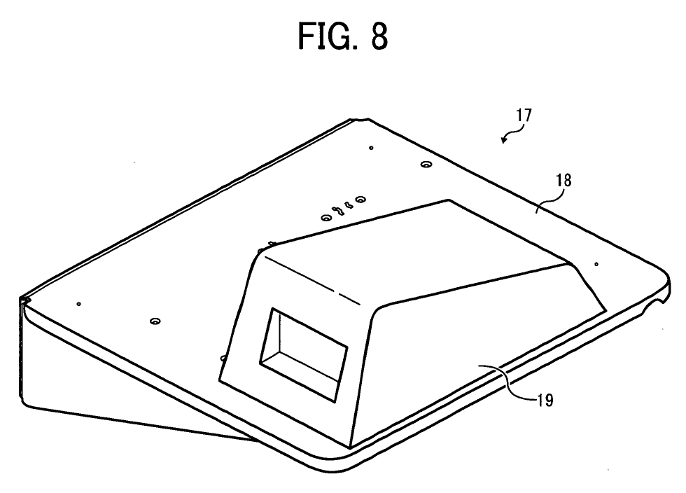

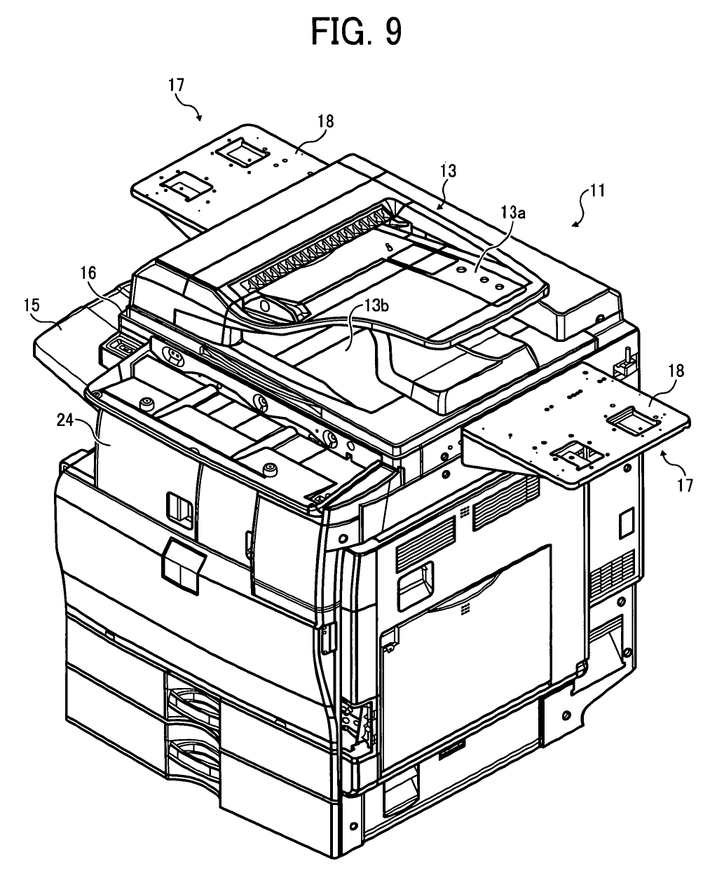

As such, the openings 18a to 18d may be formed at symmetrical positions on the attachment member 18 with respect to the centerline O1 of the attachment member 18, in which the openings 18a, and 18b may be symmetrically positioned with respect to the centerline O1 of the attachment member 18, and the openings 18c and 18d may also be symmetrically positioned with respect to the centerline O1 of the attachment member 18. Accordingly, as shown in FIGS. 4 and 8, the additional function unit 19 can be attached to the attachment member 18 even if the additional function unit 19 is rotated for 180 degrees. Therefore, the attachment member 18 can be attached to a left side or a right side of the apparatus body 12, and the additional function unit 19 can be attached to the outer end side of the attachment member 18 as shown in FIG. 9. Accordingly, a user can operate the additional function unit 19 efficiently. As shown in FIG. 3, a rear side 18R of the attachment member 18 may be aligned with a rear side 12R of the apparatus body 12, for example, but the attachment member 18 can be positioned in another position.

As above described, the image forming apparatus 11 includes the function enhancement unit 17 having the attachment member 18 and the additional function unit 19, in which the attachment member 18 is detachably attached to the one side of the apparatus body 12, and the additional function unit 19 is detachably attached to the top face of the attachment member 18.

As shown in FIGS. 1 and 2, the attachment member 18 may be disposed over the ejection tray 15 in a vertical direction, and the front side of the attachment member 18 may be positioned at a rearward with respect to the sheet centerline O (see FIG. 3) of the recording sheet S ejected on the ejection tray 15. Accordingly, when the image forming apparatus 11 is viewed from topside, the function enhancement unit 17 may partially block an access to the ejection tray 15, which means an access space for the ejection tray 15 from the front side of the image forming apparatus can be secured. Specifically, when viewed from the topside, the function enhancement unit 17 may overlap with the ejection tray 15 in the vertical direction with an area corresponding to a rear half area of the ejection tray 15 from the sheet centerline O at most. Accordingly, at least a half area of the recording sheet S placed on the ejection tray 15 can be viewed and accessed easily. The recording sheet S may be B5 sheet, for example.

As such, the image forming apparatus 11, having the ejection tray 15 projected outside, may be attached with the function enhancement unit 17 attached on the one side of the apparatus body 12. Under the above-described configuration, the recording sheet S can be taken out from the ejection tray 15 without obstruction of the function enhancement unit 17. Specifically, the recording sheet S can be taken out from the ejection tray 15 effectively without causing a user to feel obstruction when to take out the recording sheet S from the ejection tray 15.

Further, as shown in FIG. 2, the bottom face of the reinforcing member 20, projecting from the one side face of the apparatus body 12, may slant up with respect to a horizontal plane. For example, the bottom face of the reinforcing member 20 slants up to an upward direction. Accordingly, a space between the ejection tray 15 and the bottom face of the reinforcing member 20 can be set greater, by which a volume or height of the recording sheet S receivable on the ejection tray 15 can be set greater, which means the number of sheets receivable on the ejection tray 15 can be set greater.

Further, a plurality of screw holes may be formed on the one side of the apparatus body 12, and the opening portions 23a, 23b, and 23c may be formed on the fixing member 21 of the attachment member 18. The screws 22 may be screwed into the screw holes and the opening portions 23a, 23b, and 23c to attach and fix the attachment member 18 on the one side of the apparatus body 12, by which the additional function unit 19 can be connected to the apparatus body 12.

Consequently, the function enhancement unit 17 can be attached to a given position on one side of the apparatus body 12. Further, if another function enhancement unit is already attached to the one side of the apparatus body 12, the function enhancement unit 17 can be attached to another position on the same one side of the apparatus body 12, which does not interfere with another function enhancement unit.

Further, the image scanner 16 may be disposed under the contact glass 14, and the ejection tray 15 may be disposed under the image scanner 16. Because the top face of the attachment member 18 can be set to a height substantially same as the contact glass 14, the function enhancement unit 17 can be disposed at a top portion of the apparatus body 12. Accordingly, a user can operate the additional function unit 19 efficiently.

Further, the plurality of screw holes 19a to 19d may be formed on the bottom face of the additional function unit 19, and the plurality of openings 18a to 18d may be formed on the attachment member 18, wherein screws may be screwed to the screw holes 19a to 19a and the openings 18a to 18d to fix the additional function unit 19 on the attachment member 18. Each of the openings 18a to 18d can be aligned with any one of the screw holes 19a to 19d even when the additional function unit 19 is rotated for a given angle (e.g., 180 degrees). Accordingly, the additional function unit 19 can be attached to the attachment member 18 at a given position, which may be easily accessed by a user from a given direction. Accordingly, depending on a use environment of the image forming apparatus 11, the additional function unit 19 can be selectively attached to a left or right side of the image forming apparatus 11.

Further, the openings 18a to 18d may be formed symmetrical positions on the attachment member 18 with respect to the centerline O1 in the projection direction of the attachment member 18. Accordingly, as shown in FIGS. 4 and 8, the additional function unit 19 can be attached to the outer end of the attachment member 18 even if the attachment member 18 is attached to a left or right side of the image forming apparatus 11 as shown in FIG. 9. Accordingly, a user can operate the additional function unit 19 efficiently.

Further, the function enhancement unit 17 may be a billing unit, which bills a user based on types of specific services conducted by the image forming apparatus 11. Accordingly, the image forming apparatus 11 can enhance its function by adding the function enhancement unit 17.

Further, as shown in FIG. 3, the rear side 18R of the attachment member 18 may be aligned with the rear side 12R of the apparatus body 12. Accordingly, even if the image forming apparatus 11 is placed at a position closer to a wall by facing the rear side 12R of the apparatus body 12 to the wall, the function enhancement unit 17 may not interfere with the wall. Accordingly, an increase of the installation space of the image forming apparatus 11 can be prevented.

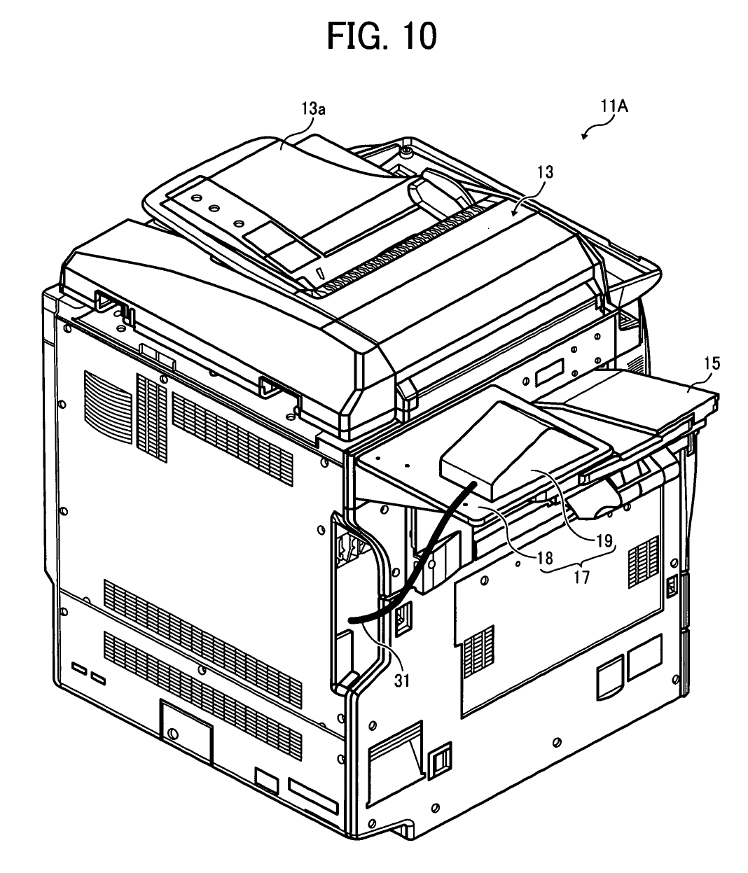

FIG. 10 shows an image forming apparatus according to a second exemplary embodiment, in which reference characters or numbers in FIGS. 1 to 9 (first exemplary embodiment) are used similarly. FIG. 10 illustrates a perspective view of an image forming apparatus 11A viewed from a rear and side direction. As shown in FIG. 10, the function enhancement unit 17 may be electrically connected to the image forming apparatus 11A using a harness 31. More specifically, one end of the harness 31 may be connected to a controller in the function enhancement unit 17 used for controlling the function enhancement unit 17, and another end of the harness 31 may be connected to a controller used for controlling the image forming apparatus 11A.

For example, as for the function enhancement unit 17, the one end of the harness 31 may be connected to a print board having the controller disposed in the additional function unit 19 via a through hole formed on a rear face of the additional function unit 19.

As such, the one end of the harness 31 may be connected to the additional function unit 19 via the through hole formed on a rear face of the additional function unit 19. Accordingly, the harness 31 can be disposed at a position distanced from the ejection tray 15. In such a configuration, the harness 31 may not interfere with the recording sheet S ejected to the ejection tray 15, by which the harness 31 may not cause a sheet jamming phenomenon.

Although the one end of the harness 31 is connected to the additional function unit 19 via the through hole formed on the rear face of the additional function unit 19, the one end of the harness 31 can be connected to the additional function unit 19 via a through hole formed on a top face of the additional function unit 19. In such a configuration, the harness 31 may not interfere with the recording sheet S ejected to the ejection tray 15, by which the harness 31 may not cause a sheet jamming phenomenon. Further, when a sheet jamming phenomenon occurs in the finisher unit of the image forming apparatus 11, the cover 24 is slidably opened for checking a sheet jamming in the finisher unit of the image forming apparatus 11. Even in such situation, the harness 31 may not interfere with the finisher unit and the ejection tray 15.

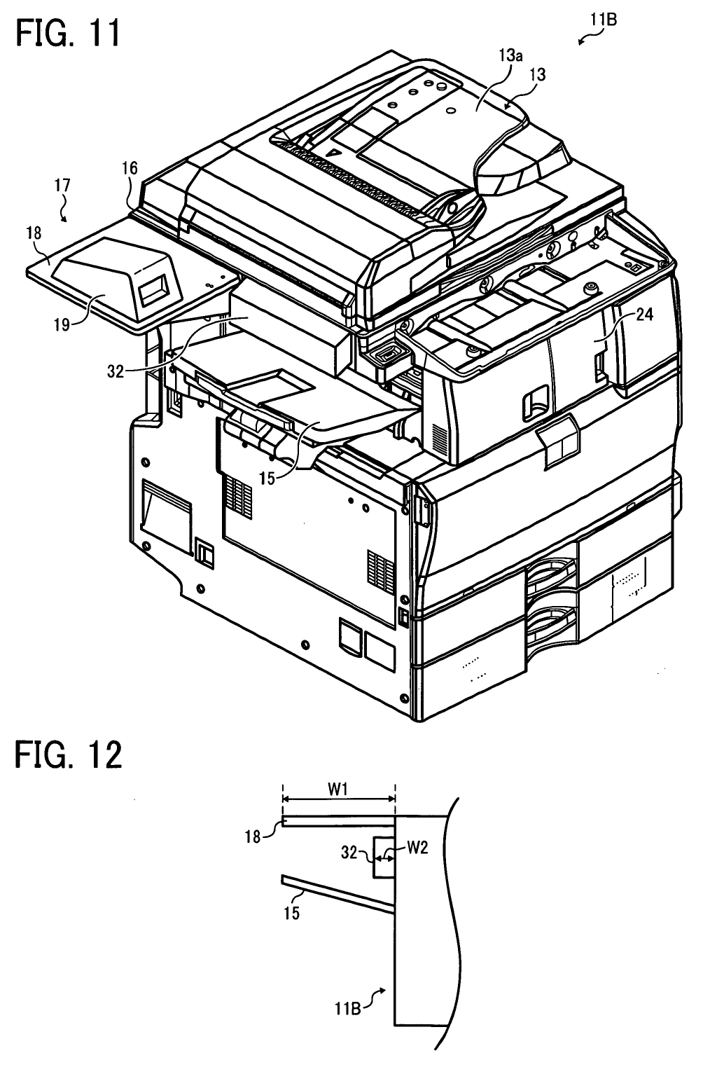

FIG. 11 shows an image forming apparatus according to a third exemplary embodiment, in which reference characters or numbers in FIG. 1 to FIG. 9 (first exemplary embodiment) are used similarly. FIG. 11 illustrates a perspective view of an image forming apparatus 11B viewed from a front and side direction.

As shown in FIG. 11, the image forming apparatus 11B includes a first function enhancement unit and a second function enhancement unit. The first function enhancement unit may be the function enhancement unit 17, and the second function enhancement unit may be a function enhancement unit 32. The function enhancement unit 32 may be disposed in front of the function enhancement unit 17, and further disposed at a space, which is under the function enhancement unit 17 and above the ejection tray 15. The function enhancement unit 32 may be detachably attached to the one side of the apparatus body 12.

When the image forming apparatus 11B is viewed from its front side, the function enhancement unit 32 may have a width W2 set smaller than a width W1 of the function enhancement unit 17 as shown in FIG. 12, in which the width W1 is a length of the attachment member projecting from the one side of the image forming apparatus 11B, and the width W2 is a width of the function enhancement unit 32 projecting from the same one side of the image forming apparatus 11B.

As such, the function enhancement unit 32 (used as the second function enhancement unit) may be disposed in front of the function enhancement unit 17 (used as the first function enhancement unit), and further disposed at a space which is under the function enhancement unit 17 and above the ejection tray 15. Further, the function enhancement unit 32 may have the width W2 set smaller than the width W1 of the function enhancement unit 17. With such configuration, a user may not feel interference of the function enhancement unit 17 and the function enhancement unit 32 when the user needs to access any one of the function enhancement unit 17 and the function enhancement unit 32.

In the above-described embodiments, the rear side 18R of the attachment member 18 may be aligned with the rear side 12R of the apparatus body 12, but the attachment member 18 can be positioned in another position. For example, the rear side 18R of the attachment member 18 can be set to a position which is forward from the rear side of the apparatus body 12. In the above-described embodiments, the ejection tray 15, projecting from the one side of the apparatus body 12, may slants up and out with respect to a horizontal plane. However, the ejection tray 15 may not need to slant up to an upward direction with respect to a horizontal plane. For example, the ejection tray 15 may extend in a horizontal direction.

As above described, an image forming apparatus according to the above described embodiments may be provided with a function enhancement unit and an ejection tray projecting from one side of the image forming apparatus, in which a recording medium can be taken out from the ejection tray efficiently even if the function enhancement unit is attached to the image forming apparatus. Such image forming apparatus having the function enhancement unit may be used as a copier, a printer, a facsimile, or a multi-functional imaging apparatus which may include copy and facsimile function, but not limited thereto.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An image forming apparatus, comprising:
an ejection tray, projecting from one side of the image forming apparatus, to receive a recording medium; and
a first function enhancement unit detachably attached to the one side of the image forming apparatus,
a bottom face of the first function enhancement unit positioned above the ejection tray,
a front side of the first function enhancement unit positioned at rearward from a sheet centerline in a sheet transport direction of the recording medium ejected onto the ejection tray.

2. The image forming apparatus according to claim 1, wherein the bottom face of the first function enhancement unit slants up and out from the one side of the image forming apparatus with respect to a horizontal plane.

3. The image forming apparatus according to claim 1, wherein the one side of the image forming apparatus includes a plurality of screw holes, the first function enhancement unit includes a plurality of opening portions to be aligned with any one of the screw holes, and the first function enhancement unit is attached to the image forming apparatus by screws engaging the screw holes and the opening portions.

4. The image forming apparatus according to claim 1, wherein the first function enhancement unit includes:
an attachment member detachably attached to the one side of the image forming apparatus, the attachment member including a plurality of openings; and
an additional function unit attached to a top face of the attachment member, the bottom face of the additional function unit having a plurality of screw holes aligned with the plurality of openings of the attachment member,
the additional function unit affixed to the attachment member with screws engaging the screw holes and the openings, and
the plurality of openings of the attachment member positioned so that the additional function unit is fixable on the attachment member even when the additional function unit is rotated for a given angle on the attachment member.

5. The image forming apparatus according to claim 4, wherein the openings in the attachment member are symmetrical with respect to a centerline of the attachment member and formed at an outer end portion of the attachment member projecting from the one side of the image forming apparatus.

6. The image forming apparatus according to claim 4, further comprising:
an image scanner to scan a document image placed on a scan face of the image scanner, the image scanner disposed at an upper portion of the image forming apparatus,
wherein the recording medium is ejected to the ejection tray by passing the recording medium under the image scanner, and
the top face of the attachment member is positioned at a height substantially same as the scan face of the image scanner.

7. The image forming apparatus according to claim 4, further comprising a harness to electrically connect the first function enhancement unit and the image forming apparatus, one end of the harness being connected to the additional function unit via a through-hole provided on one of an upper face and a rear face of the additional function unit.

8. The image forming apparatus according to claim 4, further comprising:
a second function enhancement unit detachably attached to the one side of the image forming apparatus,
the second function enhancement unit disposed in front of the first function enhancement unit and positioned under the first function enhancement unit and above the ejection tray in a vertical direction,
the second function enhancement unit having a width W2 smaller than a width W1 of the first function enhancement unit, in which the width W1 is a length of the attachment member projecting from the one side of the image forming apparatus, and the width W2 is a width of the second function enhancement unit projecting from the one side of the image forming apparatus.

9. The image forming apparatus according to claim 1, wherein a rear side of the first function enhancement unit is aligned with a rear side of the image forming apparatus, or positioned at a forward direction from the rear side of the image forming apparatus.

10. The image forming apparatus according to claim 1, wherein the first function enhancement unit comprises a billing unit.

11. An image forming apparatus, comprising:
means for receiving a recording medium ejected from the image forming apparatus, the means for receiving projecting from one side of the image forming apparatus; and
means for enhancing a function of the image forming apparatus, detachably attached to the one side of the image forming apparatus,
a bottom face of the means for enhancing positioned above the means for receiving,
a front side of the means for enhancing positioned at rearward from a sheet centerline in a sheet transport direction of the recording medium ejected onto the means for receiving.
